(19) United States
(12) Patent Application Publication
(10) Pub. No.: US 2012/0051359 A1
(43) Pub. Date: Mar. 1, 2012

(54) Apparatus and method to manage multicast data transfers in a multiple storage element system that contains data storage

(76) Inventors: John O'Brien, Short Hills, NJ (US); Ricardo Velez-McCaskey, Nashua, NH (US); Michael Joseph Levine, Nashua, NH (US)

(21) Appl. No.: 13/199,397

(22) Filed: Aug. 29, 2011

Related U.S. Application Data
(60) Provisional application No. 61/402,334, filed on Aug. 30, 2010.

(51) Int. Cl. H04L 12/56

(52) U.S. Cl. 370/390

(57) ABSTRACT

The present invention presents a system and method for providing better Management of multicast data transfers in systems which contain multiple Storage Elements, by using a Method of Intelligent Control between the host controller and the Storage Elements.

### PRIORITY INFORMATION

This application claims priority of U.S. provisional application Ser. No. 61/402,334, filed Aug. 30, 2010, entitled, “Apparatus and Method to Manage Multicast Data Transfers in a Multiple Storage Element System that Contains Data Storage”

### FIELD OF THE INVENTION

The present invention relates to the effective simultaneous transfer of data in a multicast broadcast across a data bus to at least two data storage elements, and the managing of that data relative to the transfer. In particular, the invention relates to an apparatus and method, in a system that contains at least two storage elements, for transferring as well as managing data to multiple storage elements, where that management is to achieve some specific purpose or goal.

### BACKGROUND

Methods for transmitting data over a network from a source to multiple end-points are well known. Typical examples of such transfers are broadcast, unicast, dualcast, multicast, peer-to-peer, and peer-to-peer multicast.

A commonly accepted verbatim definition of multicast, found on websites belonging to Microsoft, Cisco, EMC, Wikipedia, two issued patents (U.S. Pat. No. 7,378,960 & U.S. Pat. No. 7,541,913), one pending (20090121929) patent application, scores of blogs and other websites totaling 63 different websites is,

“the delivery of information to a group of destinations simultaneously using the most efficient strategy to deliver the messages over each link of the network only once, creating copies only when the links to the destinations split.”

Although usage in a network is more popular, the inventors of the present invention recognize that the scope of multicast has been pushed past the limitation of a network, in the above definition, to also include the environment of a bus based system.

In issued patent U.S. Pat. No. 5,720,027 Sarkozy demonstrated this by the use of multicast in a bus based system where the end unit was first armed, and then a multicast transmission was made over the bus and only the so-called targeted or armed devices acted on that transmission. This was done to shorten aggregate data transfer times.

There is strong motivation to arrange data transfers in such a simultaneous or near simultaneous fashion. On most systems, which employ multiple storage elements, one of the most time consuming events, after the mechanical delays of drives, is the serial transmission of data transfers to multiple devices. The need for these duplicate transmissions might be for data redundancy, or replication purposes, or RAID parity calculation reasons, to cite just a few examples.

A method which reduces the number of data transfers required to accomplish a storage command is very valuable and improves overall performance dramatically. The larger the amount of data to be moved, the longer it takes to transfer, and the larger the corresponding time savings. The more drive elements involved, the greater the opportunity for time savings. Harvesting these time savings boosts data transfer time dramatically.

### SUMMARY OF THE INVENTION

The inventors recognize that the prior art, although showing the way to achieve simultaneous data transfers across a system data bus, neither provides for nor suggests any way or method to manage the content of those transfers.

The prior art treats these data transfers as a node level transfer, treating the end unit as a holistic, self managing, macro type device.

It is the object of the present invention to provide an improved apparatus and method for managing multicast data transfers by adding the steps of providing for increased management of the data being transferred. This applies to both bus based and non bus based multicast systems. The purposes of managing these multicast transfers might include, but not be limited to, providing temporary data redundancy operations, encryption operations, audit control operations, data search operations, access control operations, archive operations, replication operations, or the like.

It is a further object of the present invention to provide an improved apparatus and method for managing multicast data transfers by adding the steps of providing for increased management of some process or stored data where the management function does not act upon the contents of the data being transferred, but acts in result of the transfer itself. An example of this, discussed below, would be the invocation of an alarm condition caused by accessing a specific storage address.

Consequently, we define, multicast Management or to Manage a multicast transfer as (“Management”) occurring in the context of a multicast data transfer where as a direct result of the transfer either the content of the data transferred is altered; manipulated; scheduled for some purpose, for example, archiving, deletion, virtualization; indexed for some purpose, for example, future search, data reduction purposes; flagged for some purpose, for example, an audit trail, special monitoring; encrypted; decrypted, logged for some purpose, for example, access control; or the act of transfer to a specific predefined address initiates some specific response or action, for example, alarm function or any of the actions itemized in this paragraph.

Recall that in U.S. Pat. No. 5,720,027 Sarkozy, the end point of the multicast transfer was not just an unintelligent disk drive—if there is such a thing, but rather a controller board which then attached to multiple disk drives. Accordingly, we define a storage element, (“Storage Element”) as a device (i) powered by electricity, or some other means, (ii) containing provision for data storage of any kind, (iii) with at least one data interface, (iv) including at least some processing intelligence, and (v) may include substantial processing and communication capabilities. A Storage Element is a good example of a data bus addressable device (Addressable Device”) where such a device is attached to a data bus and directly addressable by some kind of commands over that bus.

Three different examples conforming to the definition of such a Storage Element includes (1) a SCSI disk drive with an on board capability to store and execute a driver; (2) a bus based board with data processing capability with either one or more data storage devices on the board itself, or which externally connects to one or more data storage devices; or (3) a more complex system, perhaps even a stand alone server, at least operating to emulate a multicast end point as described in (1) or (2).

FIG. 5A shows a Storage Element 501 with embedded controller interface 502, processing capability 503, memory with a capability to run a driver or program within it 504, and storage media 505. An off-the-shelf SCSI drive would conform to this example.

Note that within the multicast managed system shown in FIG. 5B 511, that the collection of elements embodied by dashed box 516 also satisfies the definition of Storage Element. So too, does the total collection of elements contained in box 511.

Note also that the dashed box 516 may repeat across the bus multiple times, that is connected to the bus there may be multiple 516 boxes corresponding to multiple controller boards with associated drives.

In an embodiment of the invention, a driver or program executing within the Storage Element interfaces with a host interface intelligence. These two independently functioning resources operate in a common understanding to do more than just WRITE and READ data. They operate across a common specification to manage the data that is stored for a specific purpose, for example data encryption or decryption, or redundant copy management.

### BRIEF DESCRIPTION OF THE DRAWINGS

The features and advantages of the present invention will become apparent to those skilled in the art from the following description with reference to the drawings, in which:

FIG. 1 is a map of Storage Element IOs IOs for the Prior Art.

FIG. 2 is a map of Storage Element IOs for the present invention.

FIG. 3 is a second map of Storage Element IOs for the Prior Art

FIG. 4 shows a second map of Storage Element IOs for the present invention.

FIG. 5A shows a block diagram of a Storage Element

FIG. 5B shows a block diagram of a Managed multicast system of the present invention.

### DETAILED DESCRIPTION OF INVENTION AND .THE PREFERRED EMBODIMENTS

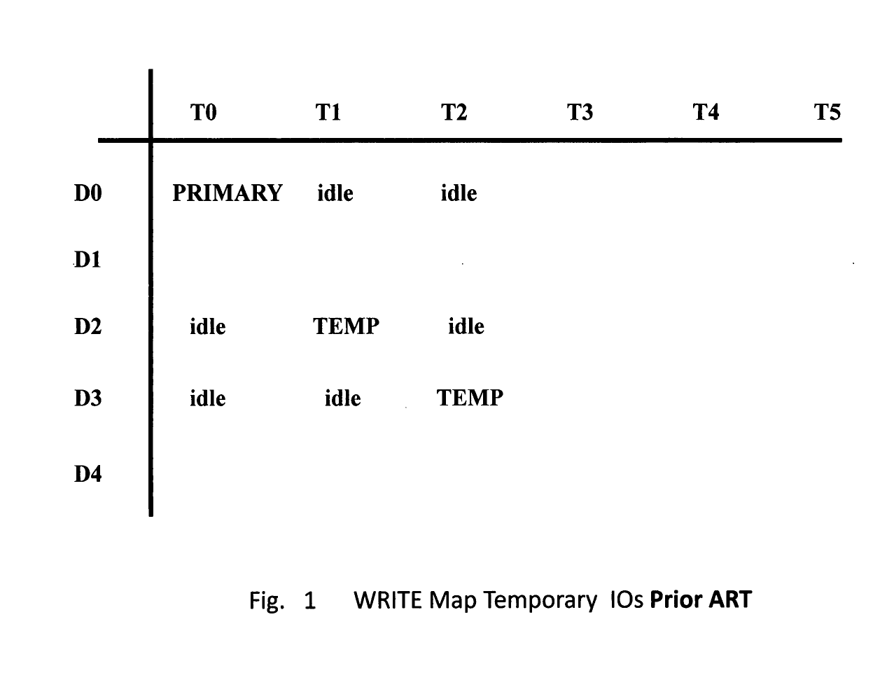

FIG. 1 shows a map of prior art WRITEs across the Storage Elements, represented as D0 thru D4 vertically down the Figure. This map of temporary WRITES is shown for 6 time periods, represented as T0 thru T5 shown horizontally across the top. Note that the multicast WRITE group in the example shown in FIG. 1, is comprised of D0, D2, & D3.

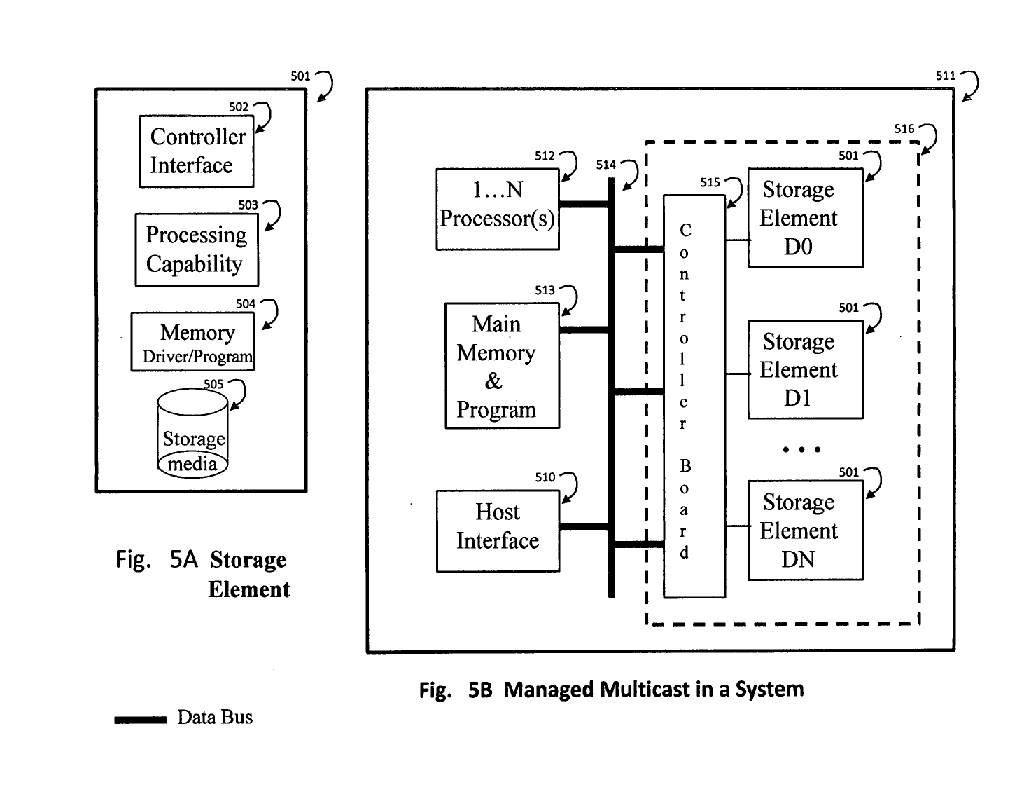

One major aspect of the present invention is an ability to manage multicast data to achieve temporary data redundancy benefits. Consider the situation where data files from a satellite burst are coming from overhead and necessitate the WRITE of very large files quickly. This data must be written with additional redundancy as a WRITE failure will cause a data loss. Three copies are required and after 1 hour, when the data has been processed, two may be removed. In this example, consider that the Storage Elements are represented as depicted in FIG. 5A.

A prior art solution, must arrange these very large WRITEs in series with idle time for the other drives. As they are large WRITEs they will overrun system cache and cause the throughput to slow down.

FIG. 1 shows the primary WRITE to D0 at time T0, then a temporary WRITE to D2 at time T1 then, a temporary WRITE at time T2 to D3. After an hour passes the host must delete the two temporary copies. As the file WRITEs are large, the time periods are large and the process is elongated.

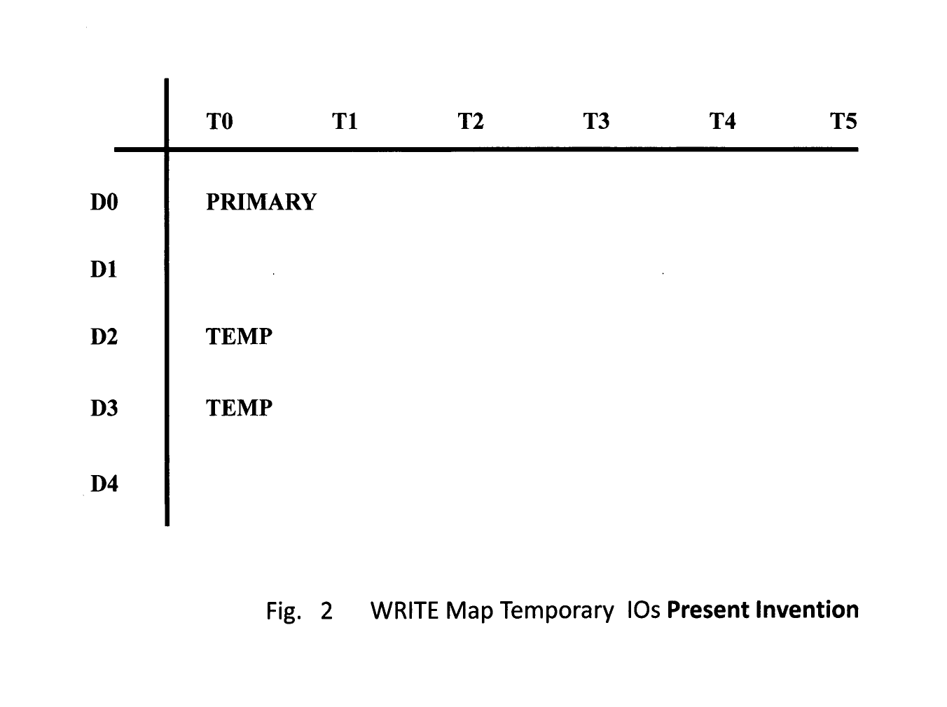

FIG. 2 shows the WRITE map for the present invention. Note that all the required WRITEs occur in a single time period, T0. In this example, a multicast WRITE was sent to three Storage Elements, D0, D2, & D3.

A method of intelligent control, (Method of Intelligent Control) is defined between the host controller and the Storage Element as some unambiguous predefined common communication. The use of a specific syntax as a Method of Intelligent Control is a simple example.

Other examples might be where the Storage Elements may have one or more predefined conditions to which they are programmed to act to some multicast transfer. Access to a specific address, for example, may invoke some security change, such as the invocation (a READ to that address) of an alarm condition, the de-invocation of an alarm condition (WRITE to that address), or the need to use one of multiple pre-stored different encryption keys, for example, by accessing the address associated with the desired key.

In such a practice, a wide range of multicast managed responses could be imagined and implemented in a system, of the present invention with Storage Elements, all without a need to change any existing command syntax of the host controller. All necessary information could be contained by the use of specially designated addresses, and the predefined context associated with those addresses, and optionally, the data written or read to or from those addresses.

Note also, that even though a multicast transfer is going to multiple Storage Elements, that each Storage Element may be configured to result in a different behavior. For example, different encryption keys might be stored in the same address of different Storage Elements, and one access of the address associated with the desired management function, could result in loading different keys for each of the different Storage Elements.

In the interest of clarity, the examples used in this specification will use syntax commands as a Method of Intelligent Control, although it is clearly stated that the present invention is not limited to the use of syntax.

In the present example, a simple syntax command was used to manage each Storage Element as to where to store the large file, whether the storage was permanent or temporary, and if temporary, how long to retain the data. Those skilled in the art can imagine several different syntax examples to achieve this. Our example is as follows.

[D0, location, size, permanent][D2, location, size, temporary, 60 minutes][D3, location, size, temporary, 60 minutes][D0, D2, D3 Data]

The drivers in Storage Elements D0, D2, & D3 are intelligent enough to recognize and act on only the control information associated with their drive designation, and to understand whether they accept a WRITE as permanent, or temporary for a fixed time. When the specified temporary time expires, Storage Elements D2 & D3 are free to allocate the corresponding location and size as free space. The specific drives may thus allocate bad blocks and sector re-allocations to that released space.

Another major aspect of the present invention is an ability to use multicast data to better manage the process of keeping a primary copy, a secondary copy, a backup copy, an archive copy, and metadata about the data being stored. In this example, consider that the Storage Elements are represented as depicted in FIG. 5B, specifically consider that all of 511 is a Storage Element. Multiple Storage Elements like these are considered to be small systems in themselves with considerable processing power and memory and capable of managing their own file system across embedded Drive Elements, controlled by a larger host system. From a performance perspective, it is desirable to modify said filesystems to make the incorporation of the managed multicast syntax usage integral to the file transfer process.

Now consider a host system connected to multiple Storage Elements as described. Our host system, in this example, wants to maintain a primary copy, a secondary copy, a backup copy, an archive copy, and metadata about the data being stored.

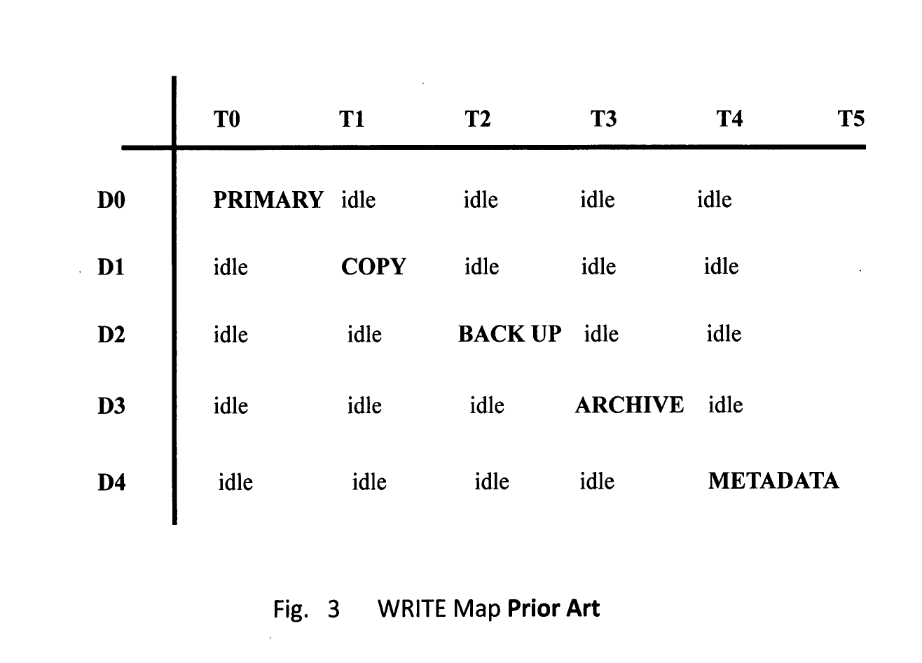

FIG. 3 shows a WRITE map for a prior art system. One can observe from this map that subsystem Storage Element DO houses the primary copy of the file, subsystem Storage Element D1 houses the secondary copy of the file, subsystem Storage Element D2 houses the Backup copy of the file, subsystem Storage Element D3 houses the Archive copy of the file, and subsystem Storage Element D4 houses the Metadata information about the various copies of the file.

For this example we assume that the length of a single time period is sufficient to transfer an entire copy of the file to be Written. Note that making all 5 transfers takes 5 full time periods.

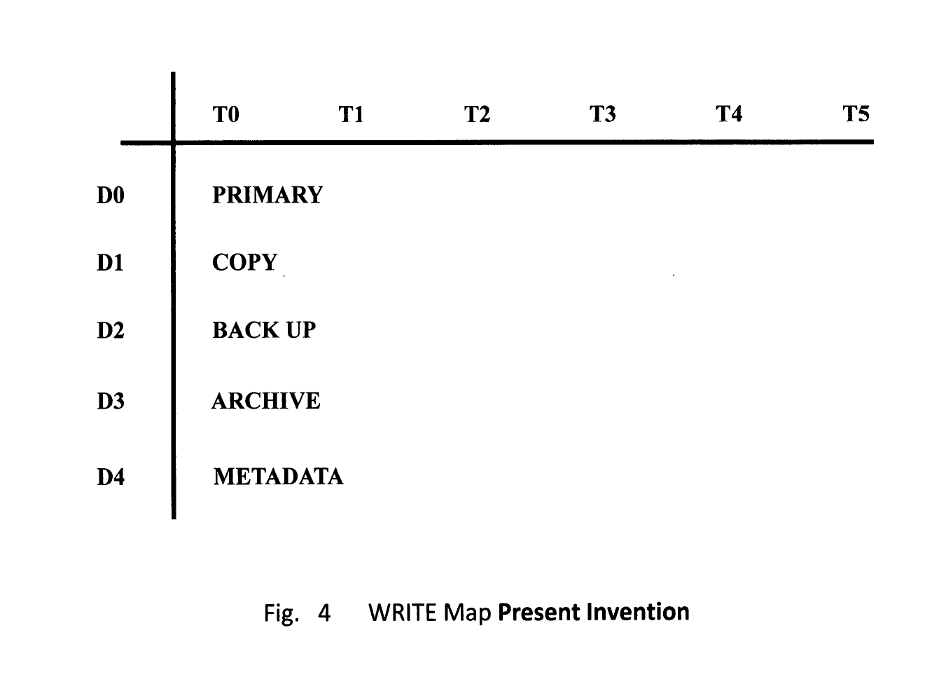

FIG. 4 shows the multicast WRITE map for the present invention for this example. Note that all WRITEs occur in time period T0—a savings of 4 time periods.

Once again, those skilled in the art can imagine their own syntax examples to achieve this. Our example is as follows.

[D0, file_name, size, primary, authorization_number][D1, file_name, size, copy, authorization_number][D2, file_name, size, back-up, authorization_number] D3, file_name, size, archive, 90 days, authorization_number] D4, file_name, size, metadata, authorization_number][D0, D1, D2, authorization_number, Data]

Note that according to the above syntax, the data is not to be actually written, at this time, for either the Archive unit, D3, or the MetaData unit, D4. Some System Administrators may choose to WRITE an Archive copy, but in this example we did not. We recorded that host request, in the syntax, that D3 is the Archive location for this transfer, and that no action be taken for 90 days. In the Archive scheduler on subsystem D3, it will record the authorization number and archive period and 90 days from this date/time it will read the Metadata for this transfer and see if there has been any access to the Primary subsystem for this file. If so, it will reset the timer for 90 days from the point of last access. If not, it will initiate a copy of the file, and after the file has been copied, it will alert the Primary that it should virtualize the Primary copy and direct a pointer to the Archive location where the file is now be located.

The authorization number is suggested to be a host assigned monotonically increasing number. Each transfer practicing this invention uses a common authorization number across that transfer. It can be used to identify a common transfer across the subsystem Storage Elements. It can also be used to index into a Metadata database concerning the control transfer information (that is the data used in the syntax command which governs a specific transfer) and which includes the date and time of the issued command. The first half of the authorization number is the date/time number as issued by the host.

Note that by including the role of the subsystem Storage Element (eg: Primary, Secondary Copy, Backup, Archive, Metadata) the host system may actually alter the role of subsystem Storage Element on a file Write by file Write basis. Thus the same subsystem Storage Element may play the role of a primary storage for one transfer and also play the roles of secondary copy in a separate transfer. This may be desirable under some circumstances.

However, the Metadata subsystem does not vary from transaction to transaction. It always remains the same.

Another major aspect of the present invention is an ability to manage a multicast transfer operation and act upon a decryption/encryption instruction.

Consider the managed multicast system shown in FIG. 5B where the Storage Elements are represented as 501. Further consider that the 515 controllers are RAID controllers addressing five Storage Elements each. The requirement for the EXCLUSIVE OR operation of RAID necessitates that multiple drives have the same data. We have seen above, how a multicast operation can achieve that.

Further suppose that the data security requirements are to encrypt it prior to storage with a different encryption key for each Storage Element.

Once again, those skilled in the art can imagine their own syntax examples to achieve this. Our example is as follows. For the case where we need to send the same information to Storage Elements D2 and D3, as well as main memory, and where we use a well known public key/private key crypto scheme where the private key has been previously stored on the various Drive Elements and stored there in some non-obvious fashion, like by partitioning the key into multiple parts and relying on operational code to reassemble it.

[D2, location, size, public-encrypt-key][D3, location, size, public-encrypt-key][D2, D3 Data]

This would enable the processing capability on the different Drive Elements to encrypt the data to be stored using the private and public keys within each drive element. The inventors note that there is always a tradeoff between performance and security. If the performance requirement would not allow a public key/private key encryption system a less rigorous encryption could be used.

In a communication process such as this, host interface board 510 in FIG. 5B would need to have its driver altered to accept the additional syntax changes beyond the standard communications protocol between host and drive controller. Host interface board 510 then receives the data transfer from the host, and multicasts it to main memory 513 and one or more internal controller boards 515. These controller boards understand and act on the new syntax, use whatever local RAID processing is required and rout the still unencrypted data to desired Drive Elements. At the Drive Element, the data is encrypted and stored.

Nothing in this specification should be understood to limit the present invention to the required use of a specific example of a managed multicast example provided in this specification . These examples are discussion points of general method and approach to use managed multicast to improve data transfers. Other possible managed multicast objectives might search functions, data de-dup functions, access control functions, for example.

Nothing in this specification should be understood to limit this invention to the use of syntax, or the use of associating actions with specific addresses as examples of a Method of Intelligent Control. Other Methods of Intelligent Control might be used for example, writing the action name desired and the parameters of various associated actions to some common address point and then decoding that data for subsequent action.

Nothing in this specification should be understood to limit this invention with a particular data bus or network. Nor should any limitation apply if a system data bus is apportioned, for any purpose, into more than one bus.

In summary, the present invention presents an apparatus and method for use in a system containing multiple Storage Elements, to Manage the process of multicast data transfers and achieve some desired goal as a result of that Management. The achievement of that goal may be synchronous or asynchronous with the completion of the transfer.

1. A method for providing management of multicast data transfers between a host controller and a computer system which contains at least two storage elements, comprising the steps of:
a) defining some method of intelligent control to be used between the host controller and the storage elements;
b) using a multicast transfer to communicate between the host controller and at least two storage elements;
c) acting by one or more of the receiving storage elements in response to said multicast transfer to achieve some management function either using the data which was transferred, or the address which was accessed during the transfer, or both.
